(19) United States
(12) Patent Application Publication
(10) Pub. No.: US 2024/0402334 A1
(43) Pub. Date: Dec. 5, 2024

(54) VEHICULAR BLIND SPOT MONITORING SYSTEM WITH ENHANCED LANE AND ROAD EDGE DETERMINATION

(71) Applicant: Magna Electronics Inc., Auburn Hills, MI (US)

(72) Inventors: Arihant Jain, Auburn Hills, MI (US); Jingyu Zhu, Rochester Hills, MI (US); Pushpendra Kushwaha, Rochester Hills, MI (US); Tejas Murlidhar Varunjikar, Troy, MI (US)

(21) Appl. No.: 18/679,552

(22) Filed: May 31, 2024

Related U.S. Application Data
(60) Provisional application No. 63/505,709, filed on Jun. 2, 2023.

(51) Int. Cl. G01S 13/931; B60Q 9/00; G01S 13/86; G06V 20/56; H04N 7/18

(52) U.S. Cl. CPC G01S 13/931; B60Q 9/00; G01S 13/867; G06V 20/588; H04N 7/183; G01S 2013/9315; G01S 2013/93274

(57) ABSTRACT

A vehicular sensing system includes a camera and a radar sensor disposed at a vehicle. The vehicular sensing system, responsive to processing of radar data, determines presence of an object within a blind spot of a driver of the equipped vehicle that is at least sideward of the equipped vehicle. The vehicular sensing system, responsive to processing of image data, determines that the equipped vehicle is within a traffic lane that borders an edge of a road. The vehicular sensing system, responsive to determining that the detected object is not sideward of a side of the equipped vehicle that is closest to the edge of the road, generates a blind spot warning. The vehicular sensing system, responsive to determining that the detected object is sideward from the side of the equipped vehicle that is closest to the edge of the road, suppresses the blind spot warning.

### CROSS REFERENCE TO RELATED APPLICATION

The present application claims the filing benefits of U.S. provisional application Ser. No. 63/505,709, filed Jun. 2, 2023, which is hereby incorporated herein by reference in its entirety.

### FIELD OF THE INVENTION

The present invention relates generally to a vehicle sensing system for a vehicle and, more particularly, to a vehicle sensing system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular sensing system includes a camera disposed at a vehicle equipped with the vehicular sensing system that views exterior of the equipped vehicle. The camera is operable to capture image data. The camera includes a CMOS imaging array that includes at least one million photosensors arranged in rows and columns. The system includes a radar sensor disposed at the equipped vehicle and sensing at least rearward and sideward of the equipped vehicle. The radar sensor is operable to capture radar data. The system includes an electronic control unit (ECU) with electronic circuitry and associated software. Image data captured by the camera is transferred to the ECU, and radar data captured by the radar sensor is transferred to the ECU. The electronic circuitry of the ECU includes at least one data processor. The ECU is operable to process (i) image data captured by the camera and transferred to the ECU and (ii) radar data captured by the radar sensor and transferred to the ECU. The vehicular sensing system, via processing at the ECU of radar data captured by the radar sensor, detects an object within a blind spot of a driver of the equipped vehicle. The blind spot is at least sideward of the equipped vehicle. The vehicular sensing system, via processing at the ECU of image data captured by the camera, determines that the equipped vehicle is within a traffic lane that borders an edge of a road along which the equipped vehicle is traveling. The vehicular sensing system, responsive to determining that the detected object is not sideward of a side of the equipped vehicle that is closest to the edge of the road, generates a blind spot warning. The vehicular sensing system, responsive to determining that the detected object is sideward from the side of the equipped vehicle that is closest to the edge of the road along which the equipped vehicle is traveling, suppresses the blind spot warning.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a sensing system that incorporates cameras and radar sensors;

FIG. 2 is a block diagram of the sensing system of FIG. 1;

FIG. 3 is a schematic view of a vehicle relative to lane markers of a traffic lane;

FIG. 4 is a schematic view of points of interest on a vehicle;

FIG. 5 is a schematic view of lane coefficient validity ranges relative to a vehicle; and

FIG. 6 is a schematic view of distances between points of interest of a vehicle and a lane marker.

### DESCRIPTION OF THE PREFERRED EMBODIMENTS

Blind spot monitoring (BSM), also known as a blind spot detection system or as blind spot assist, is an advanced driver assistance system (ADAS) feature commonly found in modern vehicles. Blind spot monitoring is designed to assist drivers in detecting and avoiding vehicles or other objects that may be in their blind spots, which are areas around the vehicle that are not directly visible to the driver through the side and rearview mirrors. The system uses sensors, typically located at the sides and/or rear of the vehicle, to continuously monitor the traffic lanes adjacent to the equipped vehicle. These sensors can detect other vehicles or other objects that enter the blind spot zones. When a vehicle is detected in the blind spot, the system alerts the driver through visual, audible, and/or tactile signals. The most common form of alert is a visual indicator, usually at the side mirrors or on the A-pillars of the equipped vehicle, which typically light up or blink to warn the driver when there is a vehicle present in the blind spot. Some systems also provide audible warnings, such as a beep or chime.

Blind spot monitor systems are especially useful during lane changes or when merging into traffic. The system acts as an additional safety measure to assist drivers in making better informed decisions and help reduce the risk of collisions caused by unnoticed vehicles in the blind spots. In some systems, one or more rear corner radar sensors at the vehicle detect relevant objects (vehicles, motorcycles, bicyclists, etc.) in the vehicle's vicinity. This sensor information is used by the system to generate alerts for the driver. In some driving scenarios, radar sensors may interpret guardrails, metal barriers, a row of parked vehicles, etc., as a moving vehicle or object. This results in a false positive alert to the driver. Implementations herein use one or more additional sensors to suppress such false positive alerts.

A vehicle sensing system and/or driver or driving assist system and/or object detection system and/or alert system operates to capture sensor data exterior of the vehicle and may process the captured sensor data to detect objects at or near the vehicle and in the predicted path of the vehicle, such as to assist a driver of the vehicle in during a lane change maneuver. The sensing system includes a data processor or data processing system that is operable to receive sensor data from one or more sensors (e.g., cameras and/or radar sensors) and may provide an output to a display device for displaying images representative of the captured sensor data. Optionally, the vision system may provide a display, such as a rearview display or a top down or bird's eye or surround view display or the like.

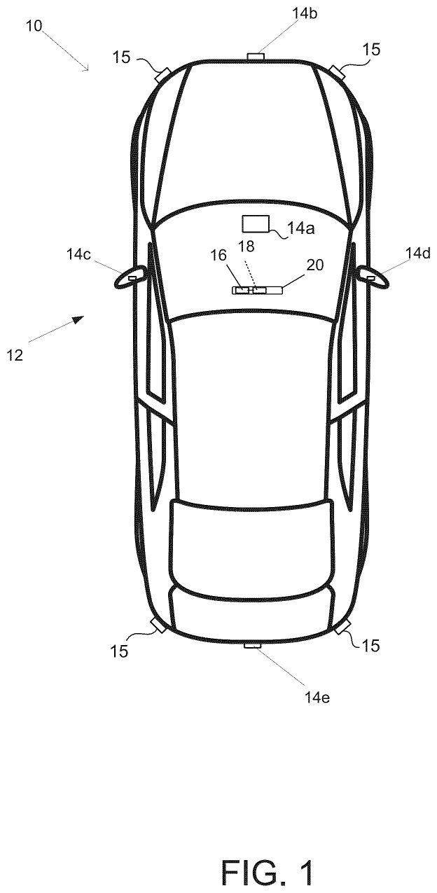

Referring now to the drawings and the illustrative embodiments depicted therein, a vehicle 10 includes a sensing system 12 that includes at least one exterior viewing imaging sensor or camera, such as a front camera module (FCM) 14a (and the system may optionally include multiple exterior viewing imaging sensors or cameras, such as a forward viewing camera 14b at the front of the vehicle, a sideward/rearward viewing camera 14c, 14d at respective sides of the vehicle, and/or a rearward viewing imaging sensor or camera 14e, such as the rear backup camera of the vehicle), which captures images exterior of the vehicle, with the camera having a lens for focusing images at or onto an imaging array or imaging plane or imager of the camera (FIG. 1). The FCM may be disposed at the windshield of the vehicle and view through the windshield and forward of the vehicle, such as for a machine vision system (such as for traffic sign recognition, headlamp control, pedestrian detection, collision avoidance, lane marker detection and/or the like). The sensing system 12 includes one or more radar sensors 15, such as corner radar sensors and/or radar sensors disposed at front, rear, or side (e.g., at the side mirrors) of the vehicle. The sensing system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

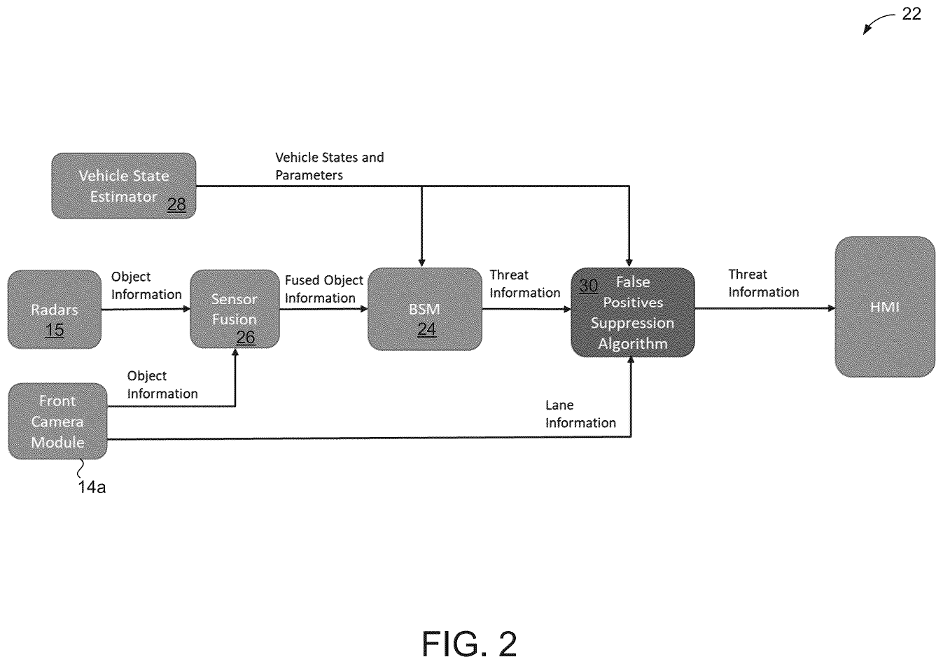

FIG. 2 includes a block diagram 22 with elements of a blind spot monitoring system (BSM) 24. The system 24 includes a FCM 14a that includes hardware and software that sends raw lane and front object information derived from image data captured by the FCM 14a (e.g., lane coefficients, quality, object relative position to the vehicle, velocity, acceleration, object type, etc.) to the BSM 24. The BSM 24 includes one or more radar sensors 15. For example, the radar sensor(s) 15 are disposed at a rear, side, or corner of the vehicle. Hardware and software of each radar sensor 15 sends raw object information derived from radar data captured by the radar sensor 15 (e.g., object relative position to the vehicle, velocity, acceleration, object type, etc.) to the BSM 24.

The system optionally includes a sensor fusion module 26. The sensor fusion module 26 receives the object information from sensors (e.g., the FCM 14a and the radar sensors 15) and combines or fuses the information to calculate an accurate position of objects detected near the vehicle along with various object parameters of the object, such as pose, velocity, acceleration, etc. Alternatively, the object information from one or more radar sensors 15 may be used directly (i.e., without first fusing object information derived from image data captured by the FCM 14a). An optional vehicle state estimator module 28 estimates various states of the equipped vehicle (e.g., vehicle speed, yaw rate, acceleration, vehicle position, etc.) using the current state and the external disturbances (e.g., road gradient and other environmental conditions). The vehicle state estimator 28 may also provide parameters for the equipped vehicle. Alternatively, information reported by vehicle sensors may be used directly.

The BSM 24 identifies any threat (e.g., other objects such as vehicles, bicycles, etc.) present in one or more blind spots of a driver of the equipped vehicle. The BSM uses information from the vehicle state estimator 28, the FCM 14a (or other camera, such as a surround view camera disposed at the front or at a side mirror of the vehicle), and the sensor fusion module 26 to determine whether any threats exist within the field of sensing of the sensors. The radar sensor(s) 15 may generate outputs defining or identifying guard-rails, barriers, rows of parked vehicles, etc., as valid and moving objects. This can lead to the blind spot monitoring system 24 incorrectly considering these objects as a threat. For example, when the equipped vehicle travels along the leftmost or rightmost traffic lane with the guard-rails present adjacent and near the equipped vehicle, the radar sensor 15 may identify the guard-rail as an object in a blind spot of the driver. A camera module (e.g., the FCM 14a and/or a surround view camera) may determine or identify a distance between the equipped vehicle and the edge of the road the vehicle is traveling along. The camera determines (or provides the information to the BSM 24 to determine) road or lane information that includes polynomial coefficients, range, and/or confidences for the left and/or right road edges.

Using this data, the BSM 24 localizes the equipped vehicle with respect to the road edges (i.e., determines the position of the vehicle relative to the left and/or right road edges) and suppresses threats when the position of the vehicle relative to the road edges indicates that the detected object is a false positive (i.e., not a moving object in a blind spot of the driver. For example, when the equipped vehicle is close to guard rails and the equipped vehicle is traveling in the leftmost or rightmost traffic lane, the radar sensor 15 may indicate the guard rails are a potential blind spot threat, but the BSM 24, using the road information derived from image data captured by the camera(s), determines that the vehicle's position relative to the road edge indicates that the guard rails are a false positive (i.e., are not a moving object in a blind spot of the driver). A false positive suppression algorithm and/or the BSM 24 may, using this information, suppress a blind spot indicator warning (e.g., a visual, audible, and/or haptic warning) that otherwise may be generated based on the radar data alone. When the image data does not indicate that a detected object is a false positive, then instead the warning will not be suppressed and the warning will be generated by a human-machine interface (HMI) module to warn or alert the driver to the object in the blind spot.

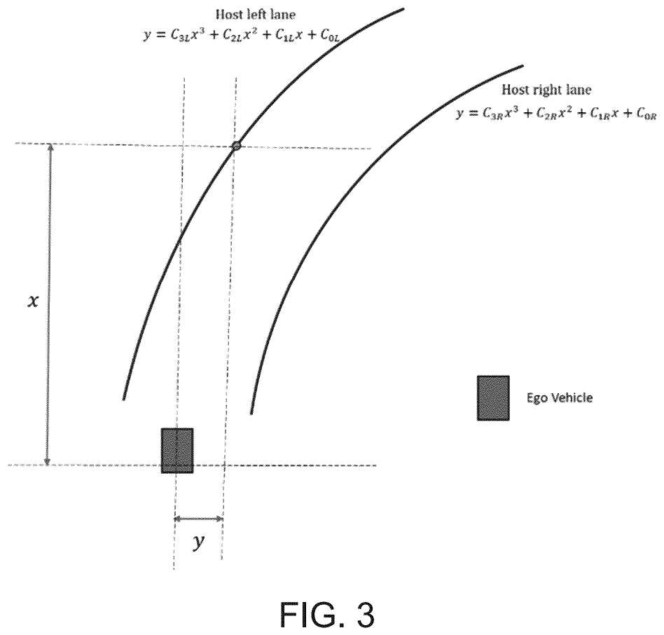

Referring now to FIG. 3, the FCM may provide information associated with the lane markers or boundaries (i.e., the road lanes and/or road boundaries of the traffic lane) as coefficients of a cubic polynomial. The FCM additionally may also provide the minimum and maximum range values for which the coefficients are valid and a confidence for the lane coefficients. The coefficients (C₃, C₂, C₁, C₀) provided are the coefficient of the following polynomial equation:

y=C₃x³+C₂x²+C₁x+C₀ (1)

Here, x represents the longitudinal distance of a point on a lane mark of a lane the vehicle is currently traveling along from the reference point of the equipped vehicle while y represents the lateral distance of the same point on the lane mark from the reference point of the equipped vehicle. Apart from the lateral distance, the range and the confidence are also parameters that may be used in determining the position of the equipped vehicle with respect to the road edges. The range may be determined as a minimum and a maximum value (e.g., based on the confidence values and one or more confidence thresholds) that defines the range of the distance in which the lane coefficients are valid. The confidence values represent how confident the system is in the location of the lane markers or edge of the road/lane the vehicle is traveling along. The confidence values may be based on factors such as environmental conditions (e.g., rain, fog, snow, etc.), the visibility of the lane markings, the terrain, ambient light values, etc.

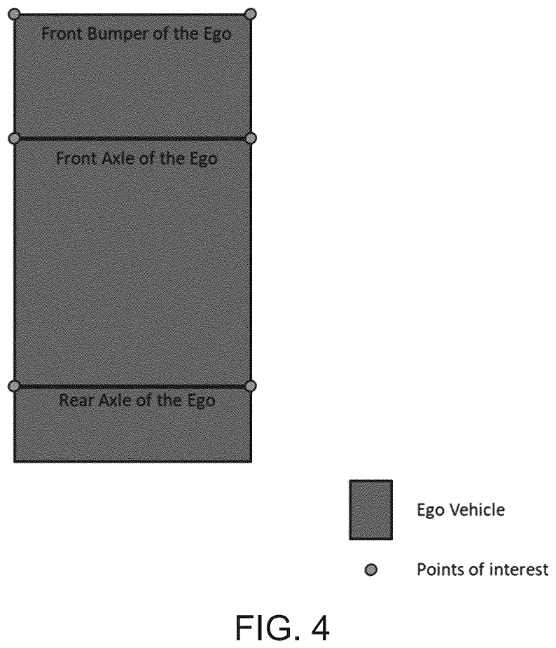

The system may precisely select the points on the vehicle to check for the lateral distance to the guard rails (or other boundary or object along the road). One implementation includes using one point of the vehicle (e.g., the center of the equipped vehicle) to determine the lateral distance to the guard rails or other object. However, this is not a very robust method and could cause issues as that point might not lie within the lane validity range of the lane information. This may provide an incorrect lateral distance to the guard rail (or other object). This method may also provide incorrect lateral distances during a lane change. Instead of using one single point, the system uses dynamically changing points according to the lane validity range. Multiple different points of interest may be evaluated by the system. For example, the system may evaluate the front bumper of the equipped vehicle, the front axle of the equipped vehicle, and/or the rear axle of the equipped vehicle (FIG. 4).

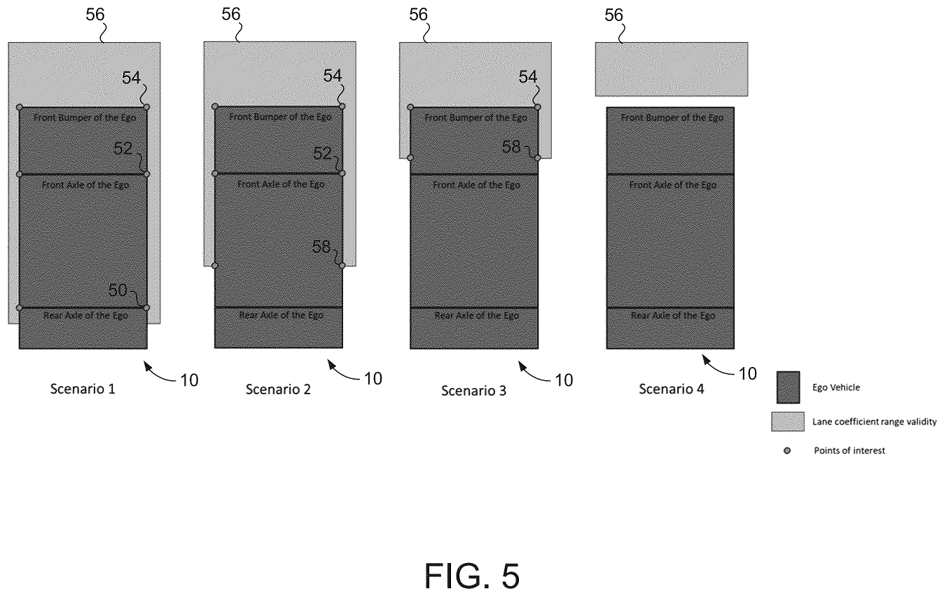

In some scenarios, the minimum lane validity range may not fall below these points. Examples of these scenarios are illustrated in FIG. 5. For example, a first scenario includes when the rear axle 50 of the equipped vehicle 10 falls within the range of the lane mark range 56 (Scenario 1). This scenario results in the best-case scenario as all three points of interest (i.e., the front bumper of the vehicle 54, the front axle of the vehicle 52, and the rear axle of the vehicle 50) are considered, and accordingly the distance of each of these points from the guard rails are considered. The points 50, 52, 54 may be located at either side of the vehicle as shown in FIG. 5 (i.e., on the left side for objects to the left of the vehicle and on the right side for objects to the right of the vehicle) or in the middle of the vehicle (i.e., along a centerline of the vehicle). In Scenario 2, the front bumper and the front axle 52 fall within the range of the valid lane mark range 56 (based on the minimum and maximum range values and confidence values) and these values are used, however the rear axle does not fall in the range. In this scenario, the rear axle distance is not considered. Instead, the minimum range point 58 that lies on the equipped vehicle (i.e., the point where the minimum range of the lane mark range 56 intersects the vehicle 10) is used along with the front axle 52 and the front bumper 54 of the equipped vehicle 10. In Scenario 3, the front bumper 54 falls within the range of the lane mark range 56, however the rear axle and the front axle do not fall within the range. In this case, the rear axle distance and the front axle distance are not considered. However, the front bumper distance 54 along with the minimum range point 58 that lies on the equipped vehicle 10 may be used for determining the position of the equipped vehicle 10 with respect to the rail guards. In Scenario 4, none of the front bumper, front axle, and rear axle are within the range of the lane mark range 56. This is the worst-case scenario, and, in this case, it is challenging to determine the position of the equipped vehicle 10 with respect to the rail guards and the estimation may not be accurate and may impact the performance of the blind spot monitoring. Therefore, in this scenario, the threats may be passed through (i.e., never suppressed). However, the system may store previously observed lane-mark information to infer the lane-mark information in this case as well.

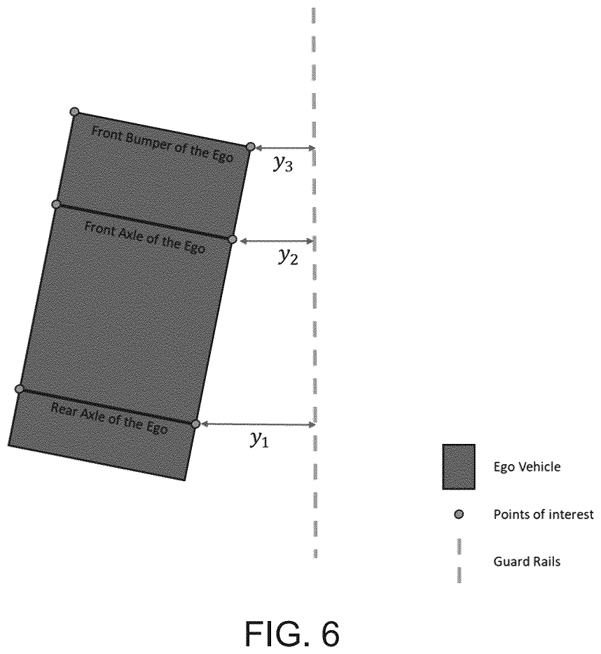

Once the points of interest are finalized (e.g., the points 50-58 of FIG. 5), the lateral distance of the road edge at each determined point is determined by using the value of the longitudinal distance of the points (i.e., x in Equation (1)). This provides the lateral distance from these points on the center of the equipped vehicle to the corresponding road edges. Half of the width of the equipped vehicle may be subtracted from this distance to obtain the distance from the side of the vehicle to the road edge. A yaw or heading or orientation of the vehicle relative to the guard rail may also be taken into account (FIG. 6). This distance may be compared with a threshold value (e.g., determine whether the distance is less than the width of a typical or standard traffic lane) to determine whether the vehicle is next to the road edge. The threshold value may be based on the orientation or heading of the vehicle, the current type of road the vehicle is traveling along, and other factors. This may be performed for each of the points of interest in the current scenario. When the lateral distances of the road edge for some or all of the points of interest are less than the threshold value, then the system may determine that the vehicle is next to the road edge. When the system determines that the vehicle is next to the road edge, the system may suppress blind spot threat warnings in the direction that is close to the lane mark. For example, when the system determines that the vehicle is in the far right traffic lane near the road edge, the system may suppress blind spot threat warnings for objects that are at least partially to the right of the vehicle. Similarly, when the system determines that the vehicle is in the far left traffic lane near the road edge, the system may suppress blind spot threat warnings for objects that are at least partially to the left of the vehicle. During scenarios where the left as well as the right road edge are close to the equipped vehicle (e.g., there is only one lane), the blind spot threat warning may be suppressed in both directions relative to the equipped vehicle.

Thus, the sensing system or blind spot monitoring system warns the driver of threats present in one or more blind spots of the driver of the vehicle using one or more radar sensors (e.g., corner radar sensors) to help avoid collision during lane changes. The system may determine when the vehicle is in a traffic lane bordering the edge of the road (e.g., the far left or far right lane of the road). In these scenarios, the system may suppress blind spot alerts for objects to the side of the vehicle that borders the road edge. The system may determine that the vehicle is in a traffic lane bordering the edge of the road using image data captured by a camera (e.g., a front camera module) and associated reported road information.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least two million photosensor elements or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controls at least one function or feature of the vehicle (such as to provide autonomous driving control of the vehicle) responsive to processing of the data captured by the radar sensors.

The radar sensor or radar sensors are disposed at the vehicle so as to sense exterior of the vehicle. For example, the radar sensors may include a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with the blind spot monitoring and alert system of the vehicle and/or a surround vision system of the vehicle, or the radar sensor may comprise a blind spot monitoring radars disposed at a rear fender of the vehicle for monitoring sideward/rearward of the vehicle for the blind spot monitoring and alert system of the vehicle. Optionally, a radar sensor or radar sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149 and/or 7,526,103, which are all hereby incorporated herein by reference in their entireties, a rain sensor, such as the types disclosed in commonly assigned U.S. Pat. Nos. 6,353,392; 6,313,454; 6,320,176 and/or 7,480,149, which are hereby incorporated herein by reference in their entireties, a vehicle vision system, such as a forward, sideward or rearward directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978 and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,881,496; 7,720,580; 7,038,577; 5,929,786 and/or 5,786,772, which are hereby incorporated herein by reference in their entireties, a video device for internal cabin surveillance and/or video telephone function, such as disclosed in U.S. Pat. Nos. 5,760,962; 5,877,897; 6,690,268; 7,370,983; 7,937,667 and/or 9,800,983, and/or U.S. Publication No. US-2006-0050018, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

The ECU may be operable to process data for at least one driving assist system of the vehicle. For example, the ECU may be operable to process data (such as image data captured by a forward viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

The system may also communicate with other systems, such as via a vehicle-to-vehicle communication system or a vehicle-to-infrastructure communication system or the like. Such car2car or vehicle to vehicle (V2V) and vehicle-to-infrastructure (car2X or V2X or V2I or a 4G or 5G broadband cellular network) technology provides for communication between vehicles and/or infrastructure based on information provided by one or more vehicles and/or information provided by a remote server or the like. Such vehicle communication systems may utilize aspects of the systems described in U.S. Pat. Nos. 10,819,943; 9,555,736; 6,690,268; 6,693,517 and/or 7,580,795, and/or U.S. Publication Nos. US-2014-0375476; US-2014-0218529; US-2013-0222592; US-2012-0218412; US-2012-0062743; US-2015-0251599; US-2015-0158499; US-2015-0124096; US-2015-0352953; US-2016-0036917 and/or US-2016-0210853, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular sensing system, the vehicular sensing system comprising:
a camera disposed at a vehicle equipped with the vehicular sensing system, the camera viewing exterior of the equipped vehicle;
wherein the camera is operable to capture image data;
wherein the camera comprises a CMOS imaging array, and wherein the CMOS imaging array comprises at least one million photosensors arranged in rows and columns;
a radar sensor disposed at the equipped vehicle, the radar sensor sensing at least rearward and sideward of the equipped vehicle;
wherein the radar sensor is operable to capture radar data;
an electronic control unit (ECU) comprising electronic circuitry and associated software;
wherein image data captured by the camera is transferred to the ECU, and wherein radar data captured by the radar sensor is transferred to the ECU;
wherein the electronic circuitry of the ECU comprises at least one data processor;
wherein the ECU is operable to process (i) image data captured by the camera and transferred to the ECU and (ii) radar data captured by the radar sensor and transferred to the ECU;
wherein the vehicular sensing system, via processing at the ECU of radar data captured by the radar sensor, detects an object within a blind spot of a driver of the equipped vehicle, and wherein the blind spot is at least sideward of the equipped vehicle;
wherein the vehicular sensing system, via processing at the ECU of image data captured by the camera, determines that the equipped vehicle is within a traffic lane that borders an edge of a road along which the equipped vehicle is traveling;
wherein the vehicular sensing system, responsive to determining that the detected object is not sideward of a side of the equipped vehicle that is closest to the edge of the road, generates a blind spot warning; and
wherein the vehicular sensing system, responsive to determining that the detected object is sideward from the side of the equipped vehicle that is closest to the edge of the road along which the equipped vehicle is traveling, suppresses the blind spot warning.

2. The vehicular sensing system of claim 1, wherein the camera is disposed at a windshield of the equipped vehicle and views forward of the equipped vehicle through the windshield of the equipped vehicle.

3. The vehicular sensing system of claim 1, wherein the camera is disposed at an exterior rearview mirror assembly disposed at the side of the equipped vehicle.

4. The vehicular sensing system of claim 1, wherein the radar sensor comprises a corner radar sensor disposed at a rear corner of the equipped vehicle.

5. The vehicular sensing system of claim 1, wherein the vehicular sensing system determines that the equipped vehicle is within the traffic lane that borders the edge of the road along which the equipped vehicle is traveling based on determining a distance between the equipped vehicle and the edge of the road.

6. The vehicular sensing system of claim 5, wherein the vehicular sensing system determines the distance between the equipped vehicle and the edge of the road based on traffic lane information determined via processing at the ECU of image data captured by the camera.

7. The vehicular sensing system of claim 6, wherein the traffic lane information comprises a cubic polynomial.

8. The vehicular sensing system of claim 5, wherein the vehicular sensing system determines a distance between at least one point of interest on the equipped vehicle and the edge of the road.

9. The vehicular sensing system of claim 8, wherein the at least one point of interest comprises at least one selected from the group consisting of (i) a first point of interest on the equipped vehicle aligned with a front bumper of the equipped vehicle, (ii) a second point of interest on the equipped vehicle aligned with a front axle of the equipped vehicle, and (iii) a third point of interest on the equipped vehicle aligned with a rear axle of the equipped vehicle.

10. The vehicular sensing system of claim 9, wherein the vehicular sensing system selects one or more of the at least one point of interest based on a minimum valid range of traffic lane information determined from image data captured by the camera.

11. The vehicular sensing system of claim 10, wherein the vehicular sensing system determines the minimum valid range of the traffic lane information based on one or more confidence values of the traffic lane information.

12. The vehicular sensing system of claim 10, wherein the vehicular sensing system determines that the third point of interest on the equipped vehicle is not within the minimum valid range of the traffic lane information, and wherein the vehicular sensing system, responsive to determining that the third point of interest on the equipped vehicle is not within the minimum valid range of the traffic lane information, selects the one or more of the at least one point of interest based further on a point where the minimum valid range of the traffic lane information intersects the equipped vehicle.

13. The vehicular sensing system of claim 5, wherein the vehicular sensing system determines that the distance between the equipped vehicle and the edge of the road is less than a width of the traffic lane of the road.

14. A vehicular sensing system, the vehicular sensing system comprising:
a camera disposed at a vehicle equipped with the vehicular sensing system, the camera viewing exterior of the equipped vehicle, wherein the camera is disposed at a windshield of the equipped vehicle and views forward of the equipped vehicle through the windshield of the equipped vehicle;
wherein the camera is operable to capture image data;
wherein the camera comprises a CMOS imaging array, and wherein the CMOS imaging array comprises at least one million photosensors arranged in rows and columns;
a radar sensor disposed at the equipped vehicle, the radar sensor sensing at least rearward and sideward of the equipped vehicle;
wherein the radar sensor is operable to capture radar data;
an electronic control unit (ECU) comprising electronic circuitry and associated software;
wherein image data captured by the camera is transferred to the ECU, and wherein radar data captured by the radar sensor is transferred to the ECU;
wherein the electronic circuitry of the ECU comprises at least one data processor;
wherein the ECU is operable to process (i) image data captured by the camera and transferred to the ECU and (ii) radar data captured by the radar sensor and transferred to the ECU;
wherein the vehicular sensing system, via processing at the ECU of radar data captured by the radar sensor, detects an object within a blind spot of a driver of the equipped vehicle, and wherein the blind spot is at least sideward of the equipped vehicle;
wherein the vehicular sensing system, via processing at the ECU of image data captured by the camera, determines that the equipped vehicle is within a traffic lane that borders an edge of a road along which the equipped vehicle is traveling based on determining a distance between the equipped vehicle and the edge of the road;
wherein the vehicular sensing system, responsive to determining that the detected object is not sideward of a side of the equipped vehicle that is closest to the edge of the road, generates a blind spot warning; and
wherein the vehicular sensing system, responsive to determining that the detected object is sideward from the side of the equipped vehicle that is closest to the edge of the road along which the equipped vehicle is traveling, suppresses the blind spot warning.

15. The vehicular sensing system of claim 14, wherein the radar sensor comprises a corner radar sensor disposed at a rear corner of the equipped vehicle.

16. The vehicular sensing system of claim 14, wherein the vehicular sensing system determines the distance between the equipped vehicle and the edge of the road based on traffic lane information determined via processing at the ECU of image data captured by the camera.

17. The vehicular sensing system of claim 14, wherein the vehicular sensing system determines a distance between at least one point of interest on the equipped vehicle and the edge of the road.

18. A vehicular sensing system, the vehicular sensing system comprising:
a camera disposed at a vehicle equipped with the vehicular sensing system, the camera viewing at least forward of the equipped vehicle;
wherein the camera is operable to capture image data;
wherein the camera comprises a CMOS imaging array, and wherein the CMOS imaging array comprises at least one million photosensors arranged in rows and columns;
a radar sensor disposed at the equipped vehicle, the radar sensor sensing at least rearward and sideward of the equipped vehicle, wherein the radar sensor comprises a corner radar sensor disposed at a rear corner of the equipped vehicle;
wherein the radar sensor is operable to capture radar data;
an electronic control unit (ECU) comprising electronic circuitry and associated software;
wherein image data captured by the camera is transferred to the ECU, and wherein radar data captured by the radar sensor is transferred to the ECU;
wherein the electronic circuitry of the ECU comprises at least one data processor;
wherein the ECU is operable to process (i) image data captured by the camera and transferred to the ECU and (ii) radar data captured by the radar sensor and transferred to the ECU;
wherein the vehicular sensing system, via processing at the ECU of radar data captured by the radar sensor, detects an object within a blind spot of a driver of the equipped vehicle, and wherein the blind spot is at least sideward of the equipped vehicle;
wherein the vehicular sensing system determines a distance between at least one point of interest on the equipped vehicle and an edge of a road along which the equipped vehicle is traveling;
wherein the vehicular sensing system, via processing at the ECU of image data captured by the camera, and responsive to determining the distance between the at least one point of interest on the equipped vehicle and the edge of the road, determines that the equipped vehicle is within a traffic lane that borders the edge of the road;
wherein the vehicular sensing system, responsive to determining that the detected object is not sideward of a side of the equipped vehicle that is closest to the edge of the road, generates a blind spot warning; and
wherein the vehicular sensing system, responsive to determining that the detected object is sideward from the side of the equipped vehicle that is closest to the edge of the road along which the equipped vehicle is traveling, suppresses the blind spot warning.

19. The vehicular sensing system of claim 18, wherein the at least one point of interest comprises at least one selected from the group consisting of (i) a first point of interest on the equipped vehicle aligned with a front bumper of the equipped vehicle, (ii) a second point of interest on the equipped vehicle aligned with a front axle of the equipped vehicle, and (iii) a third point of interest on the equipped vehicle aligned with a rear axle of the equipped vehicle.

20. The vehicular sensing system of claim 19, wherein the vehicular sensing system selects one or more of the at least one point of interest based on a minimum valid range of traffic lane information determined from image data captured by the camera.

21. The vehicular sensing system of claim 20, wherein the vehicular sensing system determines the minimum valid range of the traffic lane information based on one or more confidence values of the traffic lane information.
